(19) United States
(12) Patent Application Publication
(10) Pub. No.: US 2026/0178863 A1
(43) Pub. Date: Jun. 25, 2026

(54) MULTIMODAL REAL-TIME SIMULTANEOUS SCAN

(71) Applicant: Samsung Electronics Co., Ltd., Suwon-si (KR)

(72) Inventors: Vikrant Deoda, Santa Clara, CA (US); Eunhye Kim, Flushing, NY (US); Deepali Vinay, Milpitas, CA (US)

(21) Appl. No.: 19/261,945

(22) Filed: Jul. 7, 2025

Related U.S. Application Data
(60) Provisional application No. 63/738,032, filed on Dec. 23, 2024.

(51) Int. Cl. G06K 19/07; G06F 3/01; G06V 10/77

(52) U.S. Cl. CPC G06K 19/0723; G06V 10/7715; G06F 3/011

(57) ABSTRACT

A method includes initiating, using at least one processing device of an electronic device, a scanning operation and performing continuous scanning for one or more radio frequency identification (RFID) tags using an RFID reader operably coupled to the electronic device. The method also includes receiving, using the at least one processing device, a first set of data from the RFID reader and displaying a first set of information based on the first set of data on a user interface. The method further includes capturing, using the at least one processing device, a video feed using a camera operably coupled to the electronic device while the RFID reader is scanning for the one or more RFID tags. In addition, the method includes extracting, using the at least one processing device, a second set of data from the video feed.

### CROSS-REFERENCE TO RELATED APPLICATION AND PRIORITY CLAIM

This application claims priority under 35 U.S.C. § 119(e) to U.S. Provisional Ser. No. 63/738,032 filed on Dec. 23, 2024, which is hereby incorporated by reference in its entirety.

### TECHNICAL FIELD

This disclosure relates generally to optical scanning systems and processes. More specifically, this disclosure relates to multimodal real-time simultaneous scanning.

### BACKGROUND

In businesses with frontline workforces, product scanning involves various scenarios and use cases dependent on scanning frequency identification (RFID) tags, scanning optical codes (such as barcodes or quick response or “QR” codes), and performing augmented reality (AR) flows at different stages. However, variations between these technologies can be based on the scenarios, use cases, and user flows needed to complete different tasks. Due to differences in data retrieval from individual sensors and differences in user flows because of hardware and software limitations, each scan may be performed separately or individually without overlap, particularly from a user flow/usage perspective.

### SUMMARY

This disclosure relates to multimodal real-time simultaneous scanning.

In a first embodiment, a method includes initiating, using at least one processing device of an electronic device, a scanning operation and performing continuous scanning for one or more radio frequency identification (RFID) tags using an RFID reader operably coupled to the electronic device. The method also includes receiving, using the at least one processing device, a first set of data from the RFID reader and displaying a first set of information based on the first set of data on a user interface. The method further includes capturing, using the at least one processing device, a video feed using a camera operably coupled to the electronic device while the RFID reader is scanning for the one or more RFID tags. In addition, the method includes extracting, using the at least one processing device, a second set of data from the video feed.

In a second embodiment, an electronic device includes at least one processing device. The at least one processing device is configured to initiate a scanning operation, control an RFID reader to continuously scan for one or more RFID tags, receive a first set of data from the RFID reader, and initiate display of a first set of information based on the first set of data on a user interface of the electronic device. The at least one processing device is also configured to capture a video feed using a camera while the RFID reader is scanning for the one or more RFID tags and extract a second set of data from the video feed.

In a third embodiment, a non-transitory machine-readable medium contains instructions that when executed cause at least one processor of an electronic device to initiate a scanning operation, control an RFID reader to continuously scan for one or more RFID tags, receive a first set of data from the RFID reader, and initiate display of a first set of information based on the first set of data on a user interface of the electronic device. The non-transitory machine-readable medium also contains instructions that when executed cause the at least one processor to capture a video feed using a camera while the RFID reader is scanning for the one or more RFID tags and extract a second set of data from the video feed.

Any one or any combination of the following features may be used with the first, second, or third embodiment. A second set of information based on the second set of data may be displayed on the user interface. The video feed may include a video feed of at least one optical code, and extracting the second set of data may include extracting the second set of data from the at least one optical code. Displaying the first set of information and the second set of information on the user interface may include concurrently displaying the first set of information as a first augmented reality (AR) object and the second set of information as a second AR object, and the first AR object and the second AR object may be overlaid on the video feed. The first set of information may include first product information, the second set of information may include second product information, and the first product information and the second product information may be different. The first set of information and the second set of information may be displayed overlaid with the video feed on the user interface. An initial user input may be received before the scanning operation is initiated.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit”, “receive”, and “communicate”, as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have”, “may have”, “include”, or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to”, “designed to”, “adapted to”, “made to”, or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a”, “an”, and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include any other electronic devices now known or later developed.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism”, “module”, “device”, “unit”, “component”, “element”, “member”, “apparatus”, “machine”, “system”, “processor”, or “controller”, within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which:

FIG. 1 illustrates an example network configuration including an electronic device according to an embodiment of this disclosure;

FIG. 2 illustrates an example system for multimodal real-time simultaneous scanning according to an embodiment of this disclosure;

FIG. 3 illustrates an example scanning system architecture for multimodal real-time simultaneous scanning according to an embodiment of this disclosure;

FIG. 4 illustrates an example algorithm for multimodal real-time simultaneous scanning according to an embodiment of this disclosure;

FIGS. 5A-5D illustrate an example user interface of a multimodal real-time simultaneous scanning system according to an embodiment of this disclosure; and

FIG. 6 illustrates an example method for multimodal real-time simultaneous scanning according to an embodiment of this disclosure.

### DETAILED DESCRIPTION

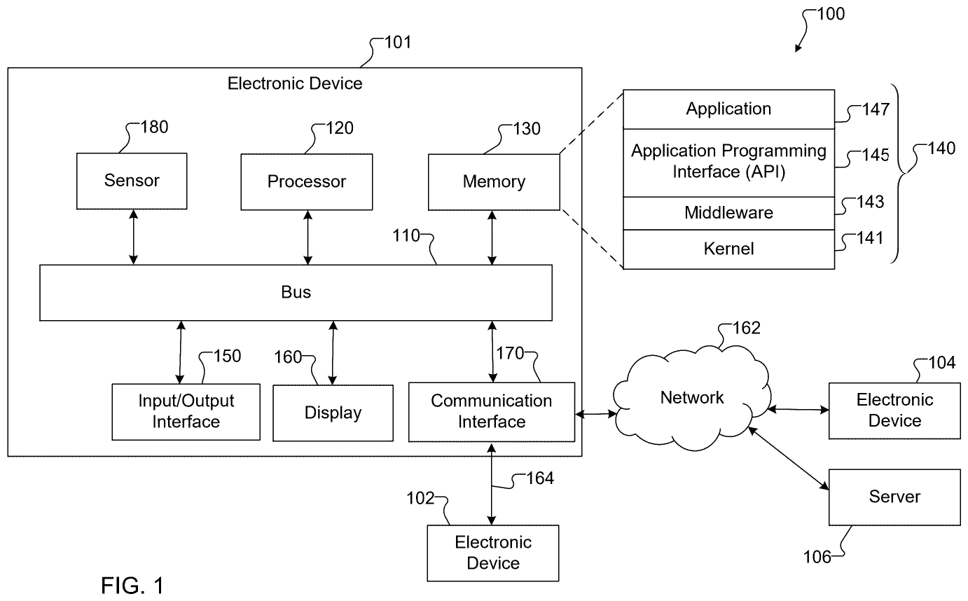

FIGS. 1 through 6, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged system or device.

As noted above, in businesses with frontline workforces, product scanning involves various scenarios and use cases dependent on scanning frequency identification (RFID) tags, scanning optical codes (such as barcodes or quick response or “QR” codes), and performing augmented reality (AR) flows at different stages. However, variations between these technologies can be based on the scenarios, use cases, and user flows needed to complete different tasks. Due to differences in data retrieval from individual sensors and differences in user flows because of hardware and software limitations, each scan may be performed separately or individually without overlap, particularly from a user flow/usage perspective.

Among other things, these shortcomings lead to limitations and issues that reduce productivity and usage. For example, users cannot use the same device to scan a barcode or QR code, scan an RFID tag, and visualize with AR concurrently. As such, there is no user flow support available to capture data for use cases from various automatic identification and data capture (AIDC) technologies simultaneously. Further, integrating multiple disparate types of data capture systems (such as RFID and optical codes) often requires a robust backend system to synchronize and process the data in real-time, along with a risk of reading the same item multiple times if both RFID and optical data are not properly matched and de-duplicated.

This disclosure provides various techniques for multimodal real-time simultaneous scanning, such as with RFID, optical codes, and AR modes. As described in more detail below, a scanning operation may be initiated, and continuous scanning for one or more RFID tags may be performed using an RFID reader. A first set of data can be obtained from the RFID reader, and first set of information based on the first set of data can be displayed. A video feed can be captured using a camera while the RFID reader is scanning for the one or more RFID tags, and a second set of data may be extracted from the video feed. In some cases, second set of information based on the second set of data may be displayed on the user interface. Also, in some cases, the video feed may represent a video feed of at least one optical code (such as a barcode or QR code), and the second set of data may be extracted from the at least one optical code. Further, in some cases, the first and second set of information may be concurrently displayed as first and second AR objects overlaid on the video feed. In this way, the disclosed techniques enable the performance of real-time multimodal scanning (such as RFID and optical code scanning with the use of AR overlays) simultaneously within the same session.

FIG. 1 illustrates an example network configuration 100 including an electronic device according to an embodiment of this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), a graphics processor unit (GPU), or a neural processing unit (NPU). The processor 120 is able to perform control on at least one of the other components of the electronic device 101 and/or perform an operation or data processing relating to communication or other functions. As described in more detail below, the processor 120 may perform various operations related to multimodal real-time simultaneous scanning, such as with RFID, optical code, and AR modes.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may support various functions related to multimodal real-time simultaneous scanning, such as with RFID, optical code, and AR modes. These functions can be performed by a single application or by multiple applications that each conduct one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second external electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high-definition multimedia interface (HDMI), recommended standard 232(RS-232 ), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, one or more sensors 180 can include one or more cameras or other imaging sensors for capturing images of scenes. The sensor(s) 180 can also include one or more buttons for touch input, one or more microphones, a gesture sensor, a gyroscope or gyro sensor, an air pressure sensor, a magnetic sensor or magnetometer, an acceleration sensor or accelerometer, a grip sensor, a proximity sensor, a color sensor (such as an RGB sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the first external electronic device 102 or the second external electronic device 104 can be a wearable device or an electronic device-mountable wearable device (such as an HMD). When the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving a separate network. The electronic device 101 can also be an augmented reality wearable device, such as eyeglasses, which include one or more imaging sensors.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the second external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support the electronic device 101 by performing at least one of operations (or functions) implemented on the electronic device 101. For example, the server 106 can include a processing module or processor that may support the processor 120 implemented in the electronic device 101. As described in more detail below, the server 106 may perform various operations related to multimodal real-time simultaneous scanning, such as with RFID, optical code, and AR modes.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

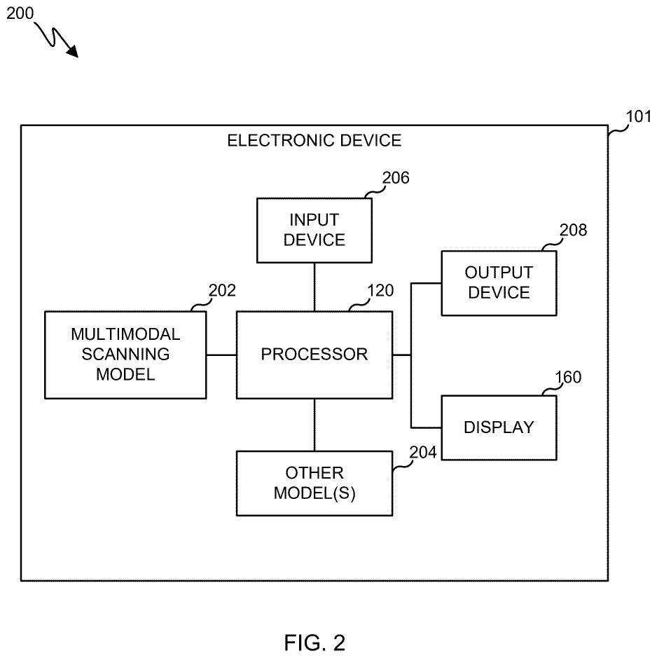

FIG. 2 illustrates an example system 200 for multimodal real-time simultaneous scanning according to an embodiment of this disclosure. For ease of explanation, the system 200 is described as involving the use of the electronic device 101 in the network configuration 100 of FIG. 1. However, the system 200 may be used with any other suitable device (such as the server 106) or a combination of devices (such as the electronic device 101 and the server 106) and in any other suitable system(s).

As shown in FIG. 2, the system 200 includes the electronic device 101, which includes the processor 120. The processor 120 is operatively coupled to or otherwise configured to use one or more machine learning models, such as one or more multimodal scanning models 202. As further described in this disclosure, the one or more multimodal scanning models 202 can include various components and sub-models, such as an RFID scanning model, an optical code scanning model, and an AR scanning model. The one or more multimodal scanning models 202 can receive one or more inputs, and the one or more multimodal scanning models 202 can operate to perform multimodal simultaneous scanning operations depending on the context or application.

The processor 120 can also be operatively coupled to or otherwise configured to use one or more other machine learning models 204, such as other models related to image processing and feature extraction. It will be understood that the machine learning models 204 can be stored in a memory of the electronic device 101 (such as the memory 130) and accessed by the processor 120 to perform image processing tasks, feature extraction tasks, and/or other tasks. However, the machine learning models 204 can be stored in any other suitable manner.

The system 200 also includes an input device 206 (such as a keyboard, touchscreen, RFID scanner, camera, etc.), an output device 208 (such as a speaker or headphones), and the display 160. The processor 120 receives one or more inputs from the input device 206 and provides the one or more inputs to the one or more multimodal scanning models 202. The processor 120 also receives one or more outputs from the one or more multimodal scanning models 202 for use, such as for display.

Although FIG. 2 illustrates one example of a system 200, various changes may be made to FIG. 2. For example, in some embodiments, the input device 206, the output device 208, and/or the display 160 can be connected to the processor 120 within the electronic device 101, such as via wired connections or circuitry. In other embodiments, the input device 206, the output device 208, and/or the display 160 can be external to the electronic device 101 and connected via wired or wireless connections. Also, in some cases, the one or more multimodal scanning models 202 and one or more of the other machine learning models 204 can be stored as separate models called upon by the processor 120 to perform certain tasks or can be included in and form a part of one or more larger machine learning models. Further, in some embodiments, one or more of the models, such as the one or more multimodal scanning models 202 or one or more of the other machine learning models 204, can be stored remotely from the electronic device 101, such as on the server 106. Here, the electronic device 101 can transmit requests including inputs to the server 106 for processing of the inputs using the machine learning models, and the results can be sent back to the electronic device 101.

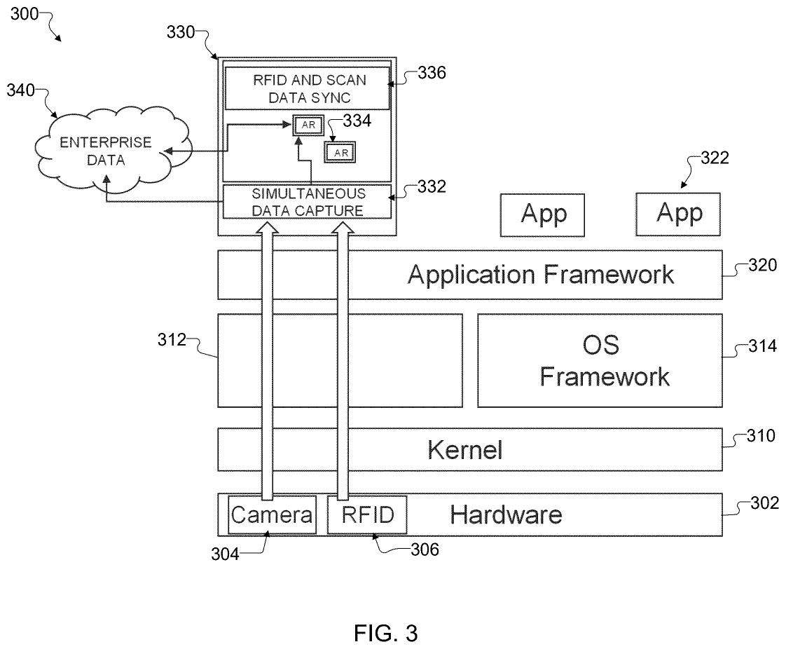

FIG. 3 illustrates an example scanning system architecture 300 for multimodal real-time simultaneous scanning according to an embodiment of this disclosure. For ease of explanation, the scanning system architecture 300 of FIG. 3 is described as being implemented using the electronic device 101 in the network configuration 100 of FIG. 1, where the electronic device 101 may implement or include the system 200 of FIG. 2. However, the scanning system architecture 300 may be implemented using any other suitable device(s) and system(s).

As shown in FIG. 3, the scanning system architecture 300 includes hardware 302 having a camera 304 and an RFID reader 306. The camera 304 may be configured for optical code scanning, such as scanning of barcodes and/or QR codes. For example, the camera 304 may be configured to capture a video feed (such as one or more image frames) of at least one optical code and optionally may pre-process the video feed (such as to adjust brightness and contrast or to remove noise).

The RFID reader 306 may initiate an RFID scan for one or more RFID tags by emitting an activation signal to any RFID tags in the vicinity. This may allow each RFID tag to transmit a response signal, such as a data signal, to the RFID reader 306. Each data signal transmitted by an RFID tag may contain tag information, such as a unique identifier (UID), and characteristic information, such as product information including an identification number of the product, origin information of the product, classification information of the product, or a combination thereof. The RFID reader 306 may receive each data signal as an input, and the RFID reader 306 may generate additional data itself (such as a timestamp of the origination scan and a location of the origination scan).

In some embodiments, the RFID reader 306 may include at least one low-frequency RFID antenna configured to operate within a frequency range of about 30 kHz to about 500 kHz, such as at about 125 kHz. The low-frequency RFID configuration may allow the RFID reader 306 to transmit and receive signals within about 50 cm or less, such as about 10 cm or less. In other embodiments, the RFID reader 306 may include at least one high-frequency RFID antenna configured to operate within a frequency range of about 3 MHz to about 30 MHz. The high-frequency RFID configuration may allow the RFID reader 306 to transmit and receive signals within about 100 cm or less, such as about 50 cm or less. Other RFID configurations may also be used, such as ultra-high frequency RFID, microwave RFID, and near-field communication (NFC).

The hardware 302 is operably coupled to a kernel 310, one or more libraries 312, and an operating system (OS) framework 314. The kernel 310, libraries 312, and OS framework 314 may be communicatively coupled to an application framework 320 to support one or more applications 322 and a multimode scan framework 330 (some or all of these components may form at least part of the software and/or program 140). The libraries 312 may store reusable functions, system calls, and resources used by the OS framework 314, the application framework 320, and the multimode scan framework 330. For example, the libraries 312 may store OS-specific functions, graphic and multimedia functions to manage rendering and image manipulation, and device driver functions to offer abstractions for the hardware 302, such as the camera 304 and the RFID reader 306.

The multimode scan framework 330 may receive input from the camera 304 and the RFID reader 306, such as by using a data capture function 332. The data capture function 332 is configured to collect, process, and integrate information from the camera 304 and the RFID reader 306. The data capture function 332 may include several sub-functions, such as one or more image preprocessing functions, RF signal processing functions, and other functions used to process video feeds and RF signals to extract relevant data.

As an example, the data capture function 332 may process a first set of data received from the RFID reader 306 to generate a first set of information, and the data capture function 332 may process a second set of data received from the camera 304 to generate a second set of information. The first set of information may include information obtained from or may be based on information obtained from one or more RFID tags, and the second set of information may include information obtained from or may be based on information obtained from optical codes. As a particular example, the data capture function 332 may include one or more detection algorithms to locate optical codes within images captured by the camera 304 and to convert the optical codes into data. In some cases, the data capture function 332 may include a convolutional neural network (CNN) configured to identify the optical codes and extract features corresponding to product information or other information from the optical codes. The data capture function 332 may include other suitable optical code detection algorithms. This configuration allows the data capture function 332 to manage multiple optical codes within an image at once and process damaged or distorted optical codes.

Additionally or alternatively, the data capture function 332 may use the first set of data and the second set of data from one or more RFID tags and one or more optical codes to retrieve the first set of information and the second set of information, respectively, from at least one remote database 340. For example, the first set of information may be obtained from one or more RFID tags and include a first portion of product information (such as product authentication information including product origination), and the second set of information may be obtained from the remote database(s) 340 and include a second portion of product information (such as product quantity or product description). Such a configuration may increase scan efficiency due to lower data storage capacity requirements, such as lower storage in an RFID tag.

The data capture function 332 may also include one or more filtering functions configured to process incoming data and remove duplicate scans, such as duplicate RFID scans of the same RFID tag, duplicate optical scans of the same optical code, or overlapping scans of an RFID tag and a related optical code. This can be done before using data obtained as a result of the RFID/optical scans, such as prior to integrating data into the remote database(s) 340 or processing the data in one or more AR functions 334.

As an example of this, each RFID tag scanned by the RFID reader 306 may contain a unique identifier (UID). The data capture function 332 may identify repeated or duplicate UIDs and remove each instance of a duplicated UID so that there is only one iteration of each UID scanned. Duplicate UIDs identified using the camera 304 may be similarly removed. The data capture function 332 may provide the received input from the hardware 302 to the one or more AR functions 334 and to a data synchronization function 336. The data capture function 332 and the one or more AR functions 334 may also be communicatively coupled to the remote database 340.

The one or more AR functions 334 allow the scanning system architecture 300 to support the use of AR when producing a video feed provided to a user. For example, the one or more AR functions 334 may allow the video feed captured using the camera 304 to be overlaid with one or more visual markers or guides on the display 160 when scanning optical codes, to be overlaid with one or more real-time product details (such as product information retrieved from the remote database(s) 340 based on data extracted from scanned optical codes), or to provide context-aware data integration. As a particular example, the one or more AR functions 334 may allow RFID data scanned from the RFID reader 306 or Global Positioning System (GPS) or other location data to be integrated with the data in the optical codes.

The data synchronization function 336 synchronizes data received from the camera 304 and the RFID reader 306 and the remote database 340. For example, the data synchronization function 336 may allow for the remote database 340 to be updated with local information, such as product information or product location information, received from optical scanning using the camera 304 and RFID scanning using the RFID reader 306. The data synchronization function 336 may also include one or more synchronization algorithms to identify inconsistencies between the data received from the camera 304 and the RFID reader 306 and subsequently correct the inconsistencies. For instance, the data synchronization function 336 may identify inconsistencies in product information for the same UIDs received from the camera 304 and the RFID reader 306. The data synchronization function 336 may rectify these inconsistencies in any suitable manner, such as based on information stored on the remote database 340.

Although FIG. 3 illustrates one example of a scanning system architecture 300 for multimodal real-time simultaneous scanning, various changes may be made to FIG. 3. For example, various components and functions in FIG. 3 may be combined, further subdivided, omitted, replicated, or rearranged according to particular needs. Also, one or more additional components, such as multiple RFID readers and/or multiple cameras, and functions may be included if needed or desired.

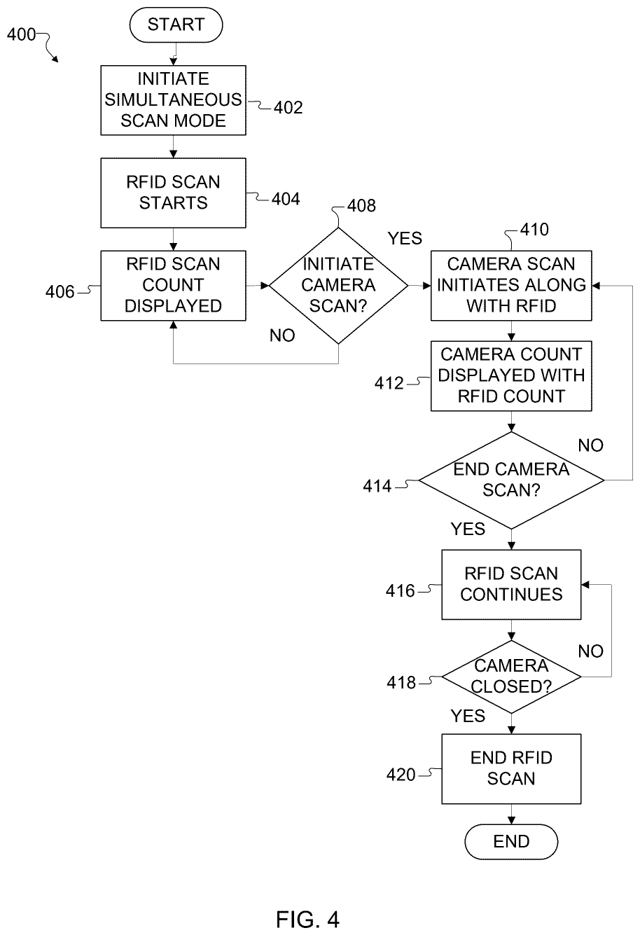

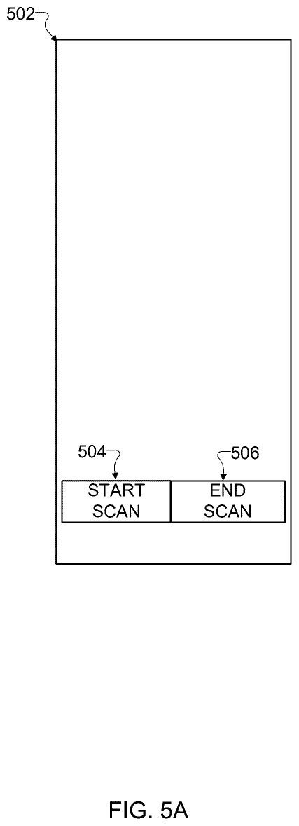

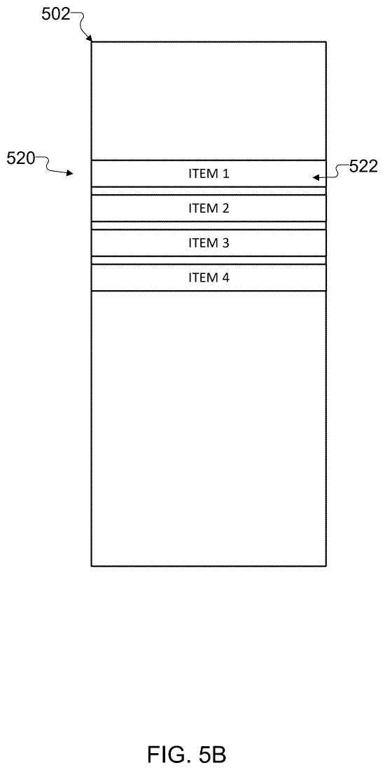

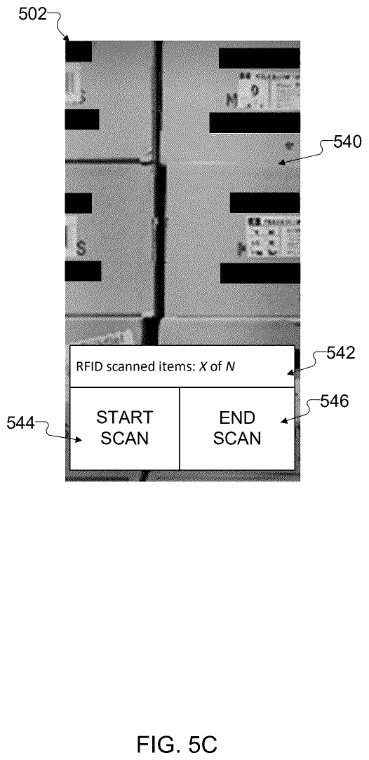

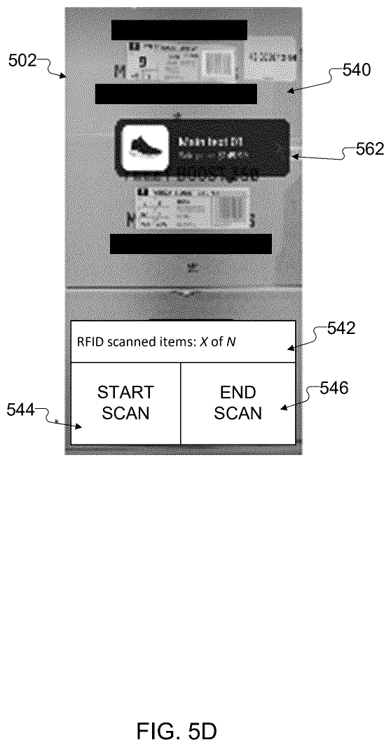

FIG. 4 illustrates an example algorithm 400 for multimodal real-time simultaneous scanning according to an embodiment of this disclosure. FIGS. 5A-5D illustrate an example user interface of a multimodal real-time simultaneous scanning system according to an embodiment of this disclosure. In some cases, the user interface can be used as part of the algorithm 400. For ease of explanation, the algorithm 400 and the user interface are described as involving the use of the electronic device 101 in the network configuration 100 of FIG. 1. However, the algorithm 400 and the user interface may be used with any other suitable device (such as the server 106) or a combination of devices (such as the electronic device 101 and the server 106) and in any other suitable system(s). Also, the algorithm 400 may be used separate from the user interface and vice versa.

As shown in FIG. 4, the algorithm 400 initiates a simultaneous scan mode in step 402. For example, as shown in FIG. 5A, a user may initiate the simultaneous scan mode using a user interface 502, which may be presented on or include a touchscreen that is part of the electronic device 101 (where the electronic device 101 can include the scanning system architecture 300). As a particular example, the user may press or otherwise interact with a start RFID scan input 504 on the display 160 of the electronic device 101.

Once the simultaneous scan mode is initiated, an RFID scan starts in step 404. For example, the RFID reader 306 may transmit or otherwise receive characteristic information from one or more RFID tags (such as tags located on product containers). The electronic device 101 may retrieve item information or other data from the remote database 340 based on the characteristic information received. The electronic device 101 may also display an RFID scan count, such as an item list 520 as shown in FIG. 5B, where the item list 520 may include one or more items 522 presented on the display, in step 406. For example, the electronic device 101 may display the item list 520, which can be an image, an interactable virtual object (such as a button), an AR object, or a combination thereof. Additionally or alternatively, the electronic device 101 may display an RFID overlay 542 as shown in FIG. 5C, where the RFID overlay 542 includes the RFID scan count or product information, on the display as an AR object.

The user may initiate a camera scan for at least one optical code, such as to scan for a barcode or QR code in step 408. For example, as shown in FIG. 5C, the user may press or otherwise interact with a start camera scan input 544 on the display. The electronic device 101 may initiate the hardware 302 and commence scanning for optical codes in step 410 using a video feed 540 captured by the camera 304. In other cases, the video feed 540 may initiate automatically, such as a predetermined period after initiating the RFID scanning operation or upon scanning a predetermined number of RFID tags.

The video feed 540 can be captured for optical code scanning concurrently with the RFID scanning operation during step 406. In other words, the electronic device 101 may receive an input from both the camera 304 and the RFID reader 306 concurrently and use both inputs in communication with the remote database 340. For example, characteristics from the optical scan using the camera 304 may be verified against the RFID scan using the RFID reader 306. Additionally or alternatively, the user may update the characteristic information (such as product information, product location in a given environment map, and product stock information) received using an AR display on the display of the electronic device 101. As such, the optical scans from the video feed 540, such as a camera count, may be displayed on the display as an optical scan overlay 562 concurrently with the RFID overlay 542 as shown in FIG. 5D in step 412. The optical scan overlay 562 may be an image, an interactable virtual object (such as a button), an AR object, or a combination thereof. In AR rendering, for example, the RFID overlay 542 may be a first AR object, and the optical scan overlay 562 may be a second AR object. Both the first AR object and the second AR object may be overlaid on the video feed 540 concurrently. The electronic device 101, based on input from a user, may repeat steps 406-412 as necessary.

The algorithm 400 may also provide an option to end the camera scan in step 414. For example, the display may include an end camera scan input 546 that a user may interact with to cease optical scanning using the camera 304. Despite optical scanning operations ceasing, the camera 304 may still continue capturing the video feed 540 and providing the video feed 540 to the display. If the optical scanning operation is stopped, the RFID reader 306 may continue the RFID scanning operation in step 416 until the video feed 540 is closed, such as by using an end RFID scan input 506 displayed on the display in step 418. The RFID scanning operation using the RFID reader 306 can subsequently end as a result in step 420.

Although FIG. 4 illustrates one example of an algorithm 400 for multimodal real-time simultaneous scanning, various changes may be made to FIG. 4. For example, various operations in FIG. 4 may be combined, further subdivided, omitted, replicated, or rearranged according to particular needs. Also, one or more additional components and functions may be included if needed or desired. Although FIGS. 5A-5D illustrate one example of a user interface 502 of a multimodal real-time simultaneous scanning system, various changes may be made to FIGS. 5A-5D. For instance, the content, layout, and arrangement of user interfaces can vary widely, and FIGS. 5A-5D do not limit the scope of this disclosure to any particular user interface. In addition, one or more additional AR objects that facilitate user-driven product synchronization with the remote database 340 or other databases or other functions may be included if needed or desired.

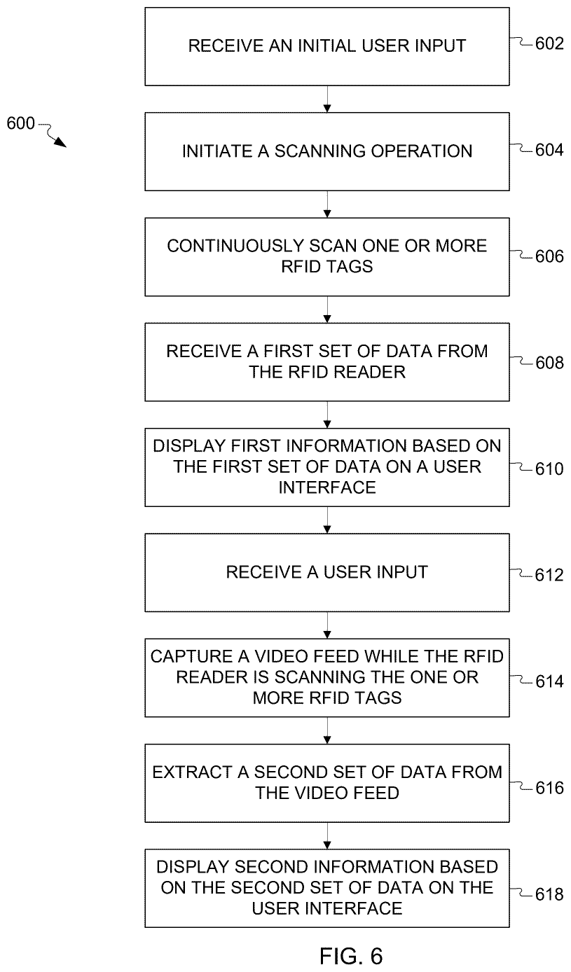

FIG. 6 illustrates an example method 600 for multimodal real-time simultaneous scanning according to an embodiment of this disclosure. For ease of explanation, the method 600 is described as involving the use of the electronic device 101 of FIG. 1 implementing the scanning system architecture 300 of FIG. 3. However, the method 600 may be used with any other suitable electronic device(s) and in any other suitable system(s).

As shown in FIG. 6, an initial user input may be received in step 602. For example, a user may initiate a simultaneous scan mode using the user interface 502 on the electronic device 101, such as by pressing or otherwise interacting with the start RFID scan input 504 on the display 160 of the electronic device 101. A scanning operation is initiated in step 604. For example, the RFID reader 306 may emit an activation signal to activate any RFID tag within its operating range (such as within about 50 cm or less). In response to emitting the activation signal, the RFID reader 306 may receive a data signal that includes characteristic information of a product from at least one RFID tag. Once the RFID scanning operation is initiated, continuous scanning may be performed for one or more RFID tags using the RFID reader 306 in step 606.

A first set of data is received from the RFID reader in step 608. For example, the one or more RFID tags may transmit characteristic information of one or more products, such as an identification number of the product, origin information of the product, classification information of the product, or a combination thereof. The RFID reader 306 may provide the first set of data corresponding to the one or more data signals received from the one or more RFID tags to the data capture function 332. The data capture function 332 may process the first set of data to generate a first set of information. Additionally or alternatively, the multimode scan framework 330, including the data capture function 332 and the data synchronization function 336, may retrieve a first set of information, such as product information, from the remote database 340 based on the characteristic information received using the RFID reader 306. The first set of information based on the first set of data is displayed on a user interface in step 610. For example, the electronic device 101 may display an RFID scan count, such as an item list 520 having one or more items 522, on the display.

A user input is received in step 612 to cause a video feed to be captured using a camera while the RFID reader is scanning for the one or more RFID tags in step 614. This may include receiving a user input from the user interface 502 and capturing a video feed 540 of at least one optical code in response to receiving the user input. For example, the user may press or otherwise interact with the start camera scan input 544 on the display. Alternatively, the video feed 540 may initiate automatically without receiving user input. The electronic device 101 can perform capture of the video feed 540 concurrently with the RFID scanning operation.

A second set of data is extracted from the video feed in step 616. This may include extracting the second set of data from the at least one optical code. For example, the camera 304 may capture one or more image frames (such as in the video feed 540) of the at least one optical code and provide the image to the data capture function 332 to pre-process the image (such as to adjust brightness and contrast or to remove noise). The data capture function 332 may use one or more detection algorithms to locate any optical code within a captured image and convert the optical code into binary data, which may be included in the second set of data. The second set of data may also optionally be transmitted to the remote database 340 to retrieve a set of a second set of information, such as product information based on the optical code.

The second set of information based on the second set of data is displayed on the user interface in step 618. For example, the first set of information and the second set of information may be displayed overlaid with the video feed 540 on the user interface 502 using the one or more AR functions 334. The first set of information may include a first set of product information, and the second set of information may include a second set of product information. The first set of information and the second set of information can be different, such as when the first set of information includes a first portion of product information (like product authentication information including product origination) and the second set of information includes a second portion of product information (like product quantity or product description).

Although FIG. 6 illustrates one example of a method 600 for multimodal real-time simultaneous scanning, various changes may be made to FIG. 6. For example, while shown as a series of steps, various steps in FIG. 6 could overlap, occur in parallel, occur in a different order, or occur any number of times (including zero times).

As can be seen from the above description, this disclosure provides systems and methods for multimodal real-time simultaneous scanning that allow a user to scan multiple optical codes, scan multiple RFID tags, and open an AR view concurrently in the same session. Also, different scan technologies may be employed with a user interface within the same session and without stopping other scans. The systems and methods of this disclosure allow for processing of scanned data from multiple AIDC technologies simultaneously and subsequent delivery to a backend with fewer or no data mismatches.

It should be noted that the functions shown in the figures or described above can be implemented in an electronic device 101, 102, 104, server 106, or other device(s) in any suitable manner. For example, in some embodiments, at least some of the functions shown in the figures or described above can be implemented or supported using one or more software applications or other software instructions that are executed by the processor 120 of the electronic device 101, 102, 104, server 106, or other device(s). In other embodiments, at least some of the functions shown in the figures or described above can be implemented or supported using dedicated hardware components. In general, the functions shown in the figures or described above can be performed using any suitable hardware or any suitable combination of hardware and software/firmware instructions. Also, the functions shown in the figures or described above can be performed by a single device or by multiple devices.

Although this disclosure has been described with example embodiments, various changes and modifications may be suggested to one skilled in the art. It is intended that this disclosure encompass such changes and modifications as fall within the scope of the appended claims.

What is claimed is:

1. A method comprising:
initiating, using at least one processing device of an electronic device, a scanning operation;
performing continuous scanning for one or more radio frequency identification (RFID) tags using an RFID reader operably coupled to the electronic device;
receiving, using the at least one processing device, a first set of data from the RFID reader;
displaying a first set of information based on the first set of data on a user interface of the electronic device;
capturing, using the at least one processing device, a video feed using a camera operably coupled to the electronic device while the RFID reader is scanning for the one or more RFID tags; and
extracting, using the at least one processing device, a second set of data from the video feed.

2. The method of claim 1, wherein:
the video feed comprises a video feed of at least one optical code; and
extracting the second set of data comprises extracting the second set of data from the at least one optical code.

3. The method of claim 1, further comprising:
displaying a second set of information based on the second set of data on the user interface.

4. The method of claim 3, wherein:
displaying the first set of information and the second set of information comprises concurrently displaying the first set of information as a first augmented reality (AR) object and the second set of information as a second AR object; and
the first AR object and the second AR object are overlaid on the video feed.

5. The method of claim 3, wherein:
the first set of information comprises first product information;
the second set of information comprises second product information; and
the first set of information and the second set of information are different.

6. The method of claim 3, wherein the first set of information and the second set of information are displayed overlaid with the video feed on the user interface.

7. The method of claim 1, further comprising:
receiving, by the at least one processing device, a user input before capturing the video feed using the camera.

8. An electronic device comprising:
at least one processing device configured to:
initiate a scanning operation;
control a radio frequency identification (RFID) reader to continuously scan for one or more RFID tags;
receive a first set of data from the RFID reader;
initiate display of a first set of information based on the first set of data on a user interface of the electronic device;
capture a video feed using a camera while the RFID reader is scanning for the one or more RFID tags; and
extract a second set of data from the video feed.

9. The electronic device of claim 8, wherein:
the video feed comprises a video feed of at least one optical code; and
the at least one processing device is configured to extract the second set of data from the at least one optical code.

10. The electronic device of claim 9, wherein the at least one processing device is further configured to initiate display of a second set of information based on the second set of data on the user interface.

11. The electronic device of claim 10, wherein:
the at least one processing device is configured to initiate concurrent display of the first set of information as a first augmented reality (AR) object and the second set of information as a second AR object; and
the first AR object and the second AR object are overlaid on the video feed.

12. The electronic device of claim 10, wherein:
the first set of information comprises first product information;
the second set of information comprises second product information; and
the first set of information and the second set of information are different.

13. The electronic device of claim 10, wherein the at least one processing device is configured to initiate the display of the first set of information and the second set of information overlaid with the video feed on the user interface.

14. The electronic device of claim 8, wherein the at least one processing device is further configured to receive a user input before capturing the video feed using the camera.

15. A non-transitory machine-readable medium containing instructions that when executed cause at least one processor of an electronic device to:
initiate a scanning operation;
control a radio frequency identification (RFID) reader to continuously scan for one or more RFID tags;
receive a first set of data from the RFID reader;
initiate display of a first set of information based on the first set of data on a user interface of the electronic device;
capture a video feed using a camera while the RFID reader is scanning for the one or more RFID tags; and
extract a second set of data from the video feed.

16. The non-transitory machine-readable medium of claim 15, wherein:
the video feed comprises a video feed of at least one optical code; and
the instructions when executed cause the at least one processor to extract the second set of data from the at least one optical code.

17. The non-transitory machine-readable medium of claim 15, further containing instructions that when executed cause the at least one processor to initiate display of a second set of information based on the second set of data on the user interface.

18. The non-transitory machine-readable medium of claim 17, wherein:
the instructions when executed cause the at least one processor to initiate concurrent display of the first set of information as a first augmented reality (AR) object and the second set of information as a second AR object; and
the first AR object and the second AR object are overlaid on the video feed.

19. The non-transitory machine-readable medium of claim 17, wherein:
the first set of information comprises first product information;
the second set of information comprises second product information; and
the first set of information and the second set of information are different.

20. The non-transitory machine-readable medium of claim 15, further containing instructions that when executed cause the at least one processor to receive a user input before capturing the video feed using the camera.
